(19) United States
(12) Patent Application Publication
(10) Pub. No.: US 2015/0355997 A1
(43) Pub. Date: Dec. 10, 2015

(54) Server-Platform Simulation Service

(71) Applicant: HEWLETT-PACKARD DEVELOPMENT COMPANY, L.P., Houston, TX (US)

(72) Inventors: Gary C Wall, Allen, TX (US); Chris Meyer, McKinney, TX (US)

(21) Appl. No.: 14/759,651

(22) PCT Filed: Jan. 15, 2013
(86) PCT No.: PCT/US13/21555

§ 371 Date: Jul. 7, 2015

(51) Int. Cl. G06F 11/36

(52) U.S. Cl. CPC G06F 11/3664

(57) ABSTRACT

A server-platform simulation service process involves receiving requests for server-platform simulation service. Simulation scenes including checkpoint simulation scenes corresponding to respective requests are identified. Respective computer hosts for executing said server-platform simulator based on the identified scenes are configured. Users are provided access to the computer hosts configured with the identified scenes.

### BACKGROUND

Software (including firmware) can be complex and many teams of developers may be involved in its development. Successful execution on one configuration of a hardware platform does not guarantee success on other configurations. Therefore, software is often tested using a variety of hardware configurations. Furthermore, platform firmware may undergo a series of revisions, so software to run on the firmware may be tested on different firmware versions and the different firmware versions may be tested on a variety of platforms. However, providing access to a variety of hardware platforms with different configurations and firmware versions can be complex and expensive.

### BRIEF DESCRIPTION OF THE DRAWINGS

The following figures represent examples and not the invention itself.

FIG. 1 is a schematic diagram of a platform-server-simulation service system in accordance with an example.

FIG. 2 is a flow chart of a platform-server-simulation service process implementable on the system of FIG. 1 in accordance with an example.

FIG. 3 is a schematic diagram of another platform-server-simulation service system in accordance with an example.

FIG. 4 is a flow chart of a platform-server-simulation service process implementable on the system of FIG. 3 in accordance with an example.

### DETAILED DESCRIPTION

Platform simulations can be used in place of various real platform hardware and firmware to relieve the cost and inconvenience of maintaining and managing actual hardware systems for test purposes. Furthermore, platform hardware can be simulated before it is realized even in prototype form; thus, firmware can be validated even before the actual hardware is available. On the other hand, server-platform simulations can be difficult, error-prone, and time-consuming to set up. Furthermore, the simulations may run slowly; for example, a firmware boot that would take minutes in a hardware system can take hours in a simulation.

To address some of these problems, server-platform simulations can be provided as a service. A developer or team of developers can request a particular platform configuration (e.g., specifying a hardware configuration and a firmware version). Responsibility for setting up the simulations is centralized at the service provider so that each development team does not have to set up their own simulations. To save boot time, a particular platform configuration can be available in multiple platform “scenes”. Each scene can correspond to a boot stage of a version of firmware in the context of particular platform hardware, as well as a particular operating system version and other software versions. In some examples, the service can provide centralized data mining of test results to characterize and to suggest improvements in firmware, simulation scenes, and in platform simulations.

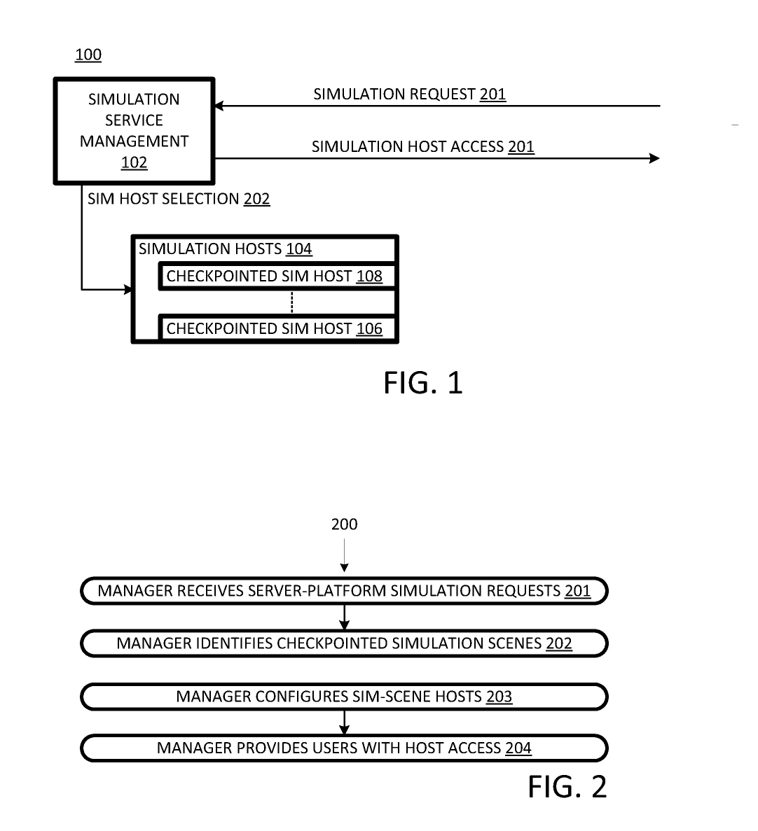

Accordingly, a platform-server-simulation system 100, shown in FIG. 1, includes simulation service management 102 and simulation hosts 104. Simulation hosts 104 include checkpointed simulation hosts 106 and 108. Herein, a simulation is “checkpointed” if it is saved or “frozen” in a non-initial state, e.g., where the firmware is in a partially or fully booted state.

Platform-server-simulation system 100 can implement a process 200, flow charted in FIG. 2. At 201, simulation service management receives requests for simulators. At 202, simulation service management identifies simulation scenes, including checkpointed simulation scenes, corresponding to the requests. At 203, simulation service management configures hosts for instances of the simulation scenes. In some cases the configuring can precede the requests; in other cases, the identifying precedes the configuring. At 204, simulation service management provides the requesting users access to the hosts configured with simulation scenes.

At a minimum, the time otherwise required to reach the checkpointed state is saved every time the checkpointed simulation is used. This can amount to about an hour per use and tens of hours per week of developer and development time. Process 200 can be implemented on systems other than system 100, and that system 100 can implement processes other than process 200.

In practice, simulation service management can receive many simulation requests from many different requestors. For example, an operating-system qualification team might request multiple instances of a platform scene with fully booted firmware so that various compatibility tests can be run in parallel on multiple instances of a single operating system, or so that different operating systems can be tested in parallel. A separate team working on part of system firmware might want to start with the firmware partially booted to a point where the system firmware is loaded into volatile memory. Once a checkpoint scene is developed for such requestors, it can be stored in the platform scene repository and allocated to hosts as needed. In some cases, platform scenes for which there is high demand may be assigned to hosts in anticipation of requests.

In some cases, a request may call for a platform scene that has not been prepared. In that case, a scene may be built by simulation service management rather than the requestor. In other words, the scene is constructed by those who main job it is to construct scenes as opposed to being constructed by those whose main job it is to create or test firmware/software. Having scene construction performed by those for whom such preparation is a primary focus can minimize errors in scene construction. Also, the specialized platform scene constructors can benefit from data mining simulation/test results for different users; this can result in improved simulation scenes.

In some cases, new scenes can be prepared before the first requests for them are received. For example, whenever a new firmware version is made available, it can be assumed there will be demand for it. Initial (unbooted) and checkpoint scenes can be developed and stored in the repository in anticipation of the requests. Requests from those interested in operating system or application capability may call for platform simulations with fully booted firmware. Those interested in checking system firmware, may want boot firmware running but not have the system firmware or management firmware already booted. This can allow debugging and other trouble-shooting operations as the system or management firmware loads.

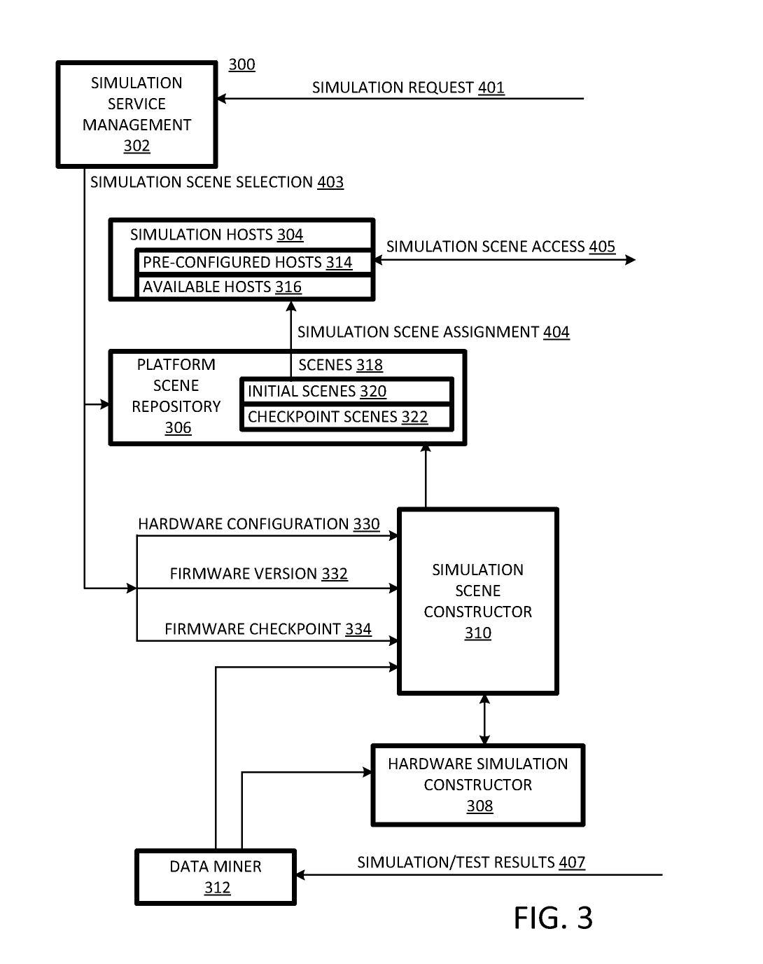

Accordingly, a simulation system 300, shown in FIG. 3, includes simulation service management 302, simulation hosts 304, a platform scene repository 306, a hardware simulation constructor 308, a simulation scene constructor 310, and a data miner 312. Each of these elements includes programmed hardware. Hardware simulation constructor provides simulations of server hardware components. Simulation hosts 304 include both pre-configured simulation hosts 314 (on which a simulation scene is pre-installed) and available simulation hosts 316 (to which a simulation scene may be assigned).

Typically, if a request is made for a simulation that can be met by an unassigned suitably pre-configured host, the requestor will be given access to such a host. However, if no such host is available, e.g., either because there is no such host or all such hosts are in use, an available host can be suitably configured in response to the request.

Platform scene repository 306 stores simulation scenes 318. A simulation scene is an initial simulator state corresponding to a (checkpointed or initial) server platform state. A server platform state includes models, configurations, and states of active hardware components (e.g., processors, memories, network interface devices, motherboards, power supplies, and fans), firmware versions, and firmware checkpoints. Simulations scenes can include initial scenes 320 and checkpoint scenes 322. An initial scene corresponds to an initial state of a server, e.g., as it is powered on or reset. A checkpoint scene corresponds to a non-initial server state, e.g., after firmware has begun to boot.

Checkpoints can be “natural” or “frozen”. A “natural” checkpoint is a post-boot server state that would normally be maintained pending further inputs, such as a user or program command to launch an operating system or application. A “frozen” checkpoint corresponds to a server state that would normally change automatically but that can be frozen, e.g., using a debugger or similarly capable utility.

If a desired scene is not available in repository 306, it can be developed. Whenever a new firmware version is made available, an initial scene for simulation can be made with little effort. The initial scene can be run so that checkpoints can be saved as checkpointed scenes. To this end, simulation scene constructor 310 can develop scenes based on inputs including hardware configuration 330, firmware version 332, and firmware checkpoint 334. The input hardware configuration is used to select a suitable hardware simulator from platform simulation constructor 308.

Simulation scene constructor 310″ provides for both manual and automatic operation. For instance, firmware developer can tweak a scene manually, e.g., by changing register values within the simulation based on experimentation, etc. A developer can then take these tweaks and make them available to a wider audience for consumption prior to submitting a firmware change to a source code base. Allowing manual checkpoints along with automated checkpoints allows for flexibility for how scenes are generated, and can save time for developers wishing to use custom non-standard scenes for their development (e.g. using firmware fixes before the fixes are fully submitted to a code base).

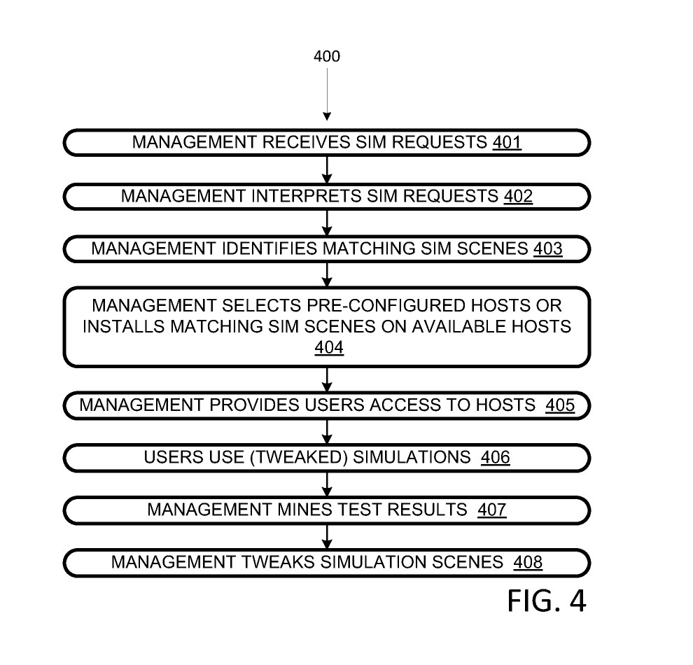

Simulation system 300 provides for implementation of a process 400, flow charted in FIG. 4. At 401, a user sends and simulation-service management receives (concurrently and/or at different times) simulation requests for a server-platform simulator.

At 402, simulation service management interprets the requests so that they can be matched with simulation scenes. At 403, simulation-service management selects matching simulation scenes.

At 404, simulation service management provides a host computer systems configured with respective selected scenes. This can involve selecting a host pre-configured with a selected scene. If there is no such pre-configured host, an instance of a selected scene can be copied from the scene repository and assigned to an available host. There can be further refinements to the host selection process if some hosts are more capable or more compatible with selected scenes than others. At 405, simulation-service management provides requesting users with access to the suitably configured hosts.

At 406, users run the simulations to which they have been provided access. Simulation/test results are then available to the user for the user's purposes. The simulation/test results are also available to simulation service management. Accordingly, at 407, the simulation service management may automatically mine simulation/test results for individual simulations, across simulations for a scene instance, across scene instances, across scenes corresponding to different firmware versions, and across firmware versions.

In some cases, analysis of the mined data may supplement evaluations of firmware being tested; the supplementary evaluations can be provided to other users interested in testing the same firmware. In some cases analysis of mined data can identify problems with simulations scenes, the platform simulation, or the simulated hardware. Where problems are identified in a scene or platform simulation, the scene or simulation can be tweaked at 408. The tweaked simulation and/or scene can then be used for future simulation runs, e.g., in future iterations of process 400.

The foregoing discussion regarding feedback and tweaking illustrates how simulation service management can serve as a central gathering point for information, data mining, and expertise in a way that would be infeasible if each developer or development team had to manage its own simulation setup. Thus, system 300 and process 400 provide for better server-platform simulations and more effective use of developer time and expertise.

Herein, a “system” is a set of interacting non-transitory tangible elements, wherein the elements can be, by way of example and not of limitation, mechanical components, electrical elements, atoms, physical encodings of instructions, and process actions. Herein, “process” refers to a sequence of actions resulting in or involving a physical transformation.

Herein, “computer” refers to a hardware machine for manipulating physically encoded data in accordance with physically encoded instructions. A “server” is a computer that performs services for other computers. A “server platform” is a design including hardware elements and firmware elements that servers may share. Depending on context, reference to a computer or server may or may not include software installed on the computer. Herein, unless other apparent from context, a functionally defined component, e.g., a constructor or miner, of a computer is a combination of hardware and software executing on that hardware to provide the defined functionality.

Herein, “platform firmware” is software encoded, at least under initial conditions, in non-volatile storage media. Platform firmware can have various components. For example, platform firmware can include: boot firmware that loads into volatile memory for the purpose of initialization and loading other firmware, but which becomes inactive once the firmware is fully booted; system firmware that remains in volatile memory after booting is complete and serves as an interface between hardware and an operating system; and management firmware that provides an interface for management that bypasses an operating system, e.g., via a lights-out module.

Herein, firmware is “fully-booted” if it has been booted to a state to which no more firmware is being loaded from non-volatile memory to volatile memory. Herein, firmware is “partially booted” if it has been booted to a state in which more firmware is to be loaded from non-volatile memory to volatile memory without external intervention. Herein, “tweaking” means “modifying”.

In this specification, related art is discussed for expository purposes. Related art labeled “prior art”, if any, is admitted prior art. Related art not labeled “prior art” is not admitted prior art. The illustrated and other described embodiments, as well as modifications thereto and variations thereupon are within the scope of the following claims.

What is claimed is:

1. A server-platform simulation service process comprising:
receiving requests for server-platform simulation service;
identifying simulation scenes including checkpoint simulation scenes corresponding to respective requests;
configuring respective computer hosts to execute the identified scenes; and
providing users access to the computer hosts configured to execute the identified scenes.

2. A server-platform simulation service process as recited in claim 1 wherein the configuring precedes the identifying for at least one of the requests.

3. A server-platform simulation service process as recited in claim 1 wherein the configuring follows the identifying for at least one of the requests.

4. A server-platform simulation service process as recited in claim 1 further comprising:
users use the simulators on the hosts to which they have been provided access; and
automatically mining simulation results.

5. A server-platform simulation service process as recited in claim 4 further comprising tweaking a simulation scene based automatically mined simulation results.

6. A server-platform simulation service process as recited in claim 5 further comprising tweaking a platform simulation based on the automatically mined simulation results, wherein the tweaking of a simulation scene is based in part of a tweaked platform simulation.

7. A server-platform simulation service process as recited in claim 1 wherein at least one of the checkpoint simulation scenes corresponds to a server-platform state in which firmware is fully booted.

8. A server-platform simulation service process as recited in claim 1 at least one of the checkpoint simulation scenes corresponds to a server-platform state in which firmware is partially booted.

9. A server-platform simulation service system comprising:
simulation hosts including simulation hosts configured with checkpointed server-platform simulation scenes; and
a simulation service manager to provide users requesting server-platform simulators access to the simulation hosts configured with the server-platform simulation scenes.

10. A server-platform simulation service system as recited in claim 9 further comprising a platform scene repository to store server-platform scenes including initial scenes and checkpoint scenes.

11. A server-platform simulation service system as recited in claim 9 wherein at least one of the checkpoint scenes corresponds to a server-platform state in which firmware is fully booted.

12. A server-platform simulation service system as recited in claim 9 wherein at least one of the checkpoint scenes corresponds to a server-platform state in which firmware is partially booted.

13. A server-platform simulation service system as recited in claim 9 further comprising a simulation scene constructor to construct a simulation scene based on specifications for hardware configuration, a firmware version, and a firmware checkpoint.

14. A server-platform simulation service system as recited in claim 13 further comprising a data miner to mine simulation and test results to yield data mining results, said simulation scene constructor being further to tweak simulation scenes based on the data mining results.

15. A server-platform simulation service system as recited in claim 14 further comprising a platform simulation constructor to tweak platform simulations based on the data mining results.

16. A server-platform simulation service system comprising plural host computers configured with plural instances of a version of firmware, the instances including versions checkpointed at different stages of a boot sequence; and
simulation service management to select a host in response to a simulation service requested based at least in part on the stage at which an instance of the version on that host is checkpointed.

17. A server-platform simulation service system as recited in claim 16 further comprising a simulation scene repository for storing differently checkpointed instances of the firmware, the simulation service management being further to install a checkpointed instance of the software on a host in response to a request for a simulation service.
